(19) United States
(12) Patent Application Publication
(10) Pub. No.: US 2013/0149579 A1
(43) Pub. Date: Jun. 13, 2013

(54) SECONDARY BATTERY

(71) Applicant: YongKyun Park, Yongin-si (KR)

(72) Inventor: YongKyun Park, Yongin-si (KR)

(21) Appl. No.: 13/565,638

(22) Filed: Aug. 2, 2012

(30) Foreign Application Priority Data
Dec. 7, 2011 (KR) 10-2011-0130507

(51) Int. Cl. H01M 10/36; H01M 10/02

(52) U.S. Cl. 429/94; 429/152

(57) ABSTRACT

An electrode assembly including a first electrode plate having a plurality of first electrode tabs, wherein each one of the first electrode tabs is attached to a region generally opposite to and facing each another of the first electrode tabs; a second electrode plate having a plurality of second electrode tabs, wherein each one of the second electrode tabs is attached to a region generally opposite to and facing each another of the second electrode tabs; and a separator located between the first electrode plate and the second electrode plate.

### CROSS-REFERENCE TO RELATED APPLICATION

This application claims priority to and the benefit of Korean Patent Application No. 10-2011-0130507, filed on Dec. 7, 2011, in the Korean Intellectual Property Office, and titled: “ELECTRODE ASSEMBLY AND SECONDARY BATTERY HAVING THE SAME,” the entire content of which is incorporated by reference herein.

### BACKGROUND

1. Field

Embodiments relate to an electrode assembly and a secondary battery having the same.

2. Description of Related Art

Generally, unlike a primary battery, a secondary battery may be recharged and may include a nickel hydrogen (NiMH) battery, a nickel cadmium (Ni-Cd) battery, a lithium battery, and so on. In particular, lithium secondary batteries are quickly gaining favor because their operating voltage of 3.7V is three times greater than nickel batteries, which have been widely used as power sources for portable electronic equipment, and because of their high energy density per unit weight.

Lithium secondary batteries can be classified into a liquid electrolyte battery and a polymer electrolyte battery according to the kind of electrolyte used. In general, a battery employing a liquid electrolyte is referred to as a lithium ion battery and a battery employing a solid electrolyte is referred to as a lithium polymer battery.

### SUMMARY

Embodiments are directed to an electrode assembly which can suppress cell deterioration by forming current input and output paths on opposite sides while preventing concentrated local heat generation, and a secondary battery having the same.

According to aspects of the present invention, an electrode assembly is provided, including a positive electrode plate having positive electrode tabs attached to opposite regions facing each other, a negative electrode plate having negative electrode tabs attached to opposite regions facing each other, and a separator located between the positive electrode plate and the negative electrode plate.

The positive electrode plate may include a first side and a second side parallel with each other; the negative electrode plate may include a first side and a second side parallel with each other; the positive electrode tabs may include a first positive electrode tab extending to the outside through the first side of the positive electrode plate and a second positive electrode tab extending to the outside through the second side of the positive electrode plate; and the negative electrode tabs may include a first negative electrode tab extending to the outside through the first side of the negative electrode plate and a second negative electrode tab extending to the outside through the second side of the negative electrode plate.

An imaginary first line connecting the first positive electrode tab and the second positive electrode tab and an imaginary second line connecting the first negative electrode tab and the second negative electrode tab may be parallel with each other.

An imaginary first line connecting the first positive electrode tab and the second positive electrode tab and an imaginary second line connecting the first negative electrode tab and the second negative electrode tab may intersect with each other.

The positive electrode plate, the separator and the negative electrode plate may be stacked.

The positive electrode tabs and the negative electrode tabs may also be stacked.

The positive electrode plate, the separator and the negative electrode plate may be wound.

The positive electrode plate, the separator and the negative electrode plate may be shaped of squares or rectangles.

According to aspects of the present invention, an electrode assembly is provided, including a positive electrode plate including a positive electrode collector plate, a positive electrode active material coated on the positive electrode collector plate and positive electrode tabs attached to opposite regions of the positive electrode collector plate facing each other, a negative electrode plate including a negative electrode collector plate, a negative electrode active material coated on the negative electrode collector plate and negative electrode tabs attached to opposite regions of the negative electrode collector plate facing each other, and a separator located between the positive electrode plate and the negative electrode plate.

The positive electrode collector plate may include a first side and a second side parallel with each other; the negative electrode collector plate may include a first side and a second side parallel with each other; the positive electrode tabs may include a first positive electrode tab extending to the outside through the first side of the positive electrode collector plate and a second positive electrode tab extending to the outside through the second side of the positive electrode collector plate; and the negative electrode tabs may include a first negative electrode tab extending to the outside through the first side of the negative electrode collector plate and a second negative electrode tab extending to the outside through the second side of the negative electrode collector plate.

According to aspects of the present invention, a secondary battery is provided, including the electrode assembly stated above.

The secondary battery may further include a sheath member surrounding the electrode assembly, wherein the sheath member includes a first sheath member contacting one side of the electrode assembly, and a second sheath member contacting the other side of the electrode assembly, the sheath member surrounding the electrode assembly.

The sheath member may have an adhesion part that adheres the first and second sheath members to a region corresponding to the outside of the electrode assembly.

The positive electrode tabs and the negative electrode tabs may extend to the outside of the sheath member through the adhesion part.

The positive electrode member and the negative electrode member may extend to the outside of the sheath member through the adhesion part, the positive electrode tabs may be coupled to the positive electrode member from the inside of the sheath member, and the negative electrode tabs may be coupled to the negative electrode member from the inside of the sheath member;

As described above, in the electrode assembly according to the embodiments of the present invention and the secondary battery having the same, cell deterioration can be suppressed by forming current input and output paths in opposite sides while preventing concentrated local heat generation.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features will become more apparent to those of ordinary skill in the art by describing in detail exemplary embodiments with reference to the attached drawings, in which:

FIG. 1A is a plan view of an electrode assembly according to an embodiment of the present invention;

FIG. 1B is an exploded perspective view of FIG. 1A;

FIG. 1C is a cross-sectional view taken along the line 1c-1c of FIG. 1A;

FIG. 2A is a plan view of an electrode assembly according to another embodiment of the present invention;

FIG. 2B is an exploded perspective view of FIG. 2A;

FIG. 3A is a perspective view of an electrode assembly according to another embodiment of the present invention;

FIG. 3B is an exploded perspective view illustrating an unwound electrode assembly of FIG. 3A;

FIG. 4A is a perspective view of an electrode assembly according to another embodiment of the present invention;

FIG. 4B is an exploded perspective view illustrating an unwound electrode assembly of FIG. 4A;

FIG. 5A illustrates a secondary battery according to another embodiment of the present invention;

FIG. 5B is a cross-sectional view taken along the line 5a-5a of FIG. 5A;

FIG. 6A illustrates a secondary battery according to another embodiment of the present invention;

FIG. 6B is a cross-sectional view taken along the line 6a-6a of FIG. 6A;

FIG. 7A illustrates a secondary battery according to another embodiment of the present invention;

FIG. 7B is a cross-sectional view taken along the line 7a-7a of FIG. 7A; and

FIG. 8A illustrates a secondary battery according to another embodiment of the present invention;

FIG. 8B is a cross-sectional view taken along the line 8a-8a of FIG. 8A.

### DETAILED DESCRIPTION OF THE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

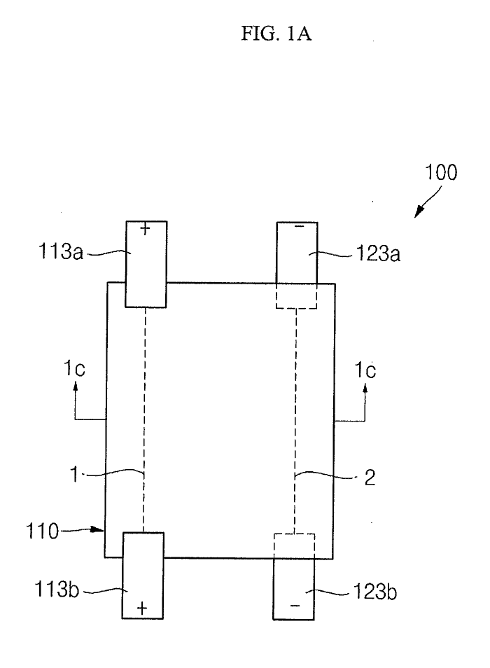

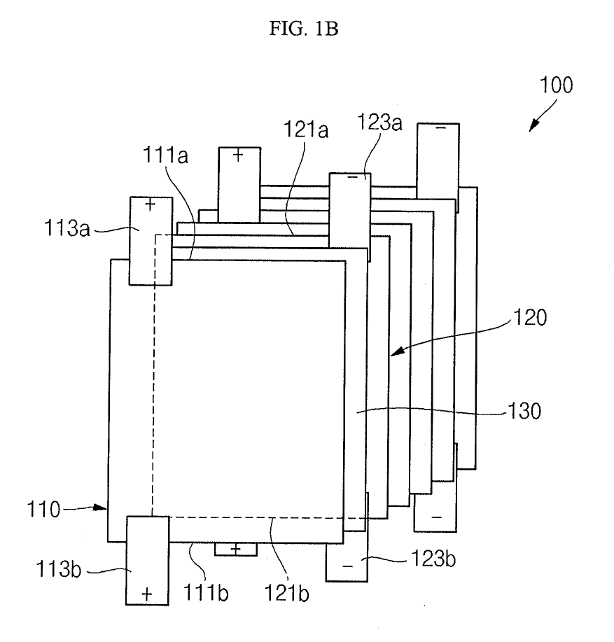

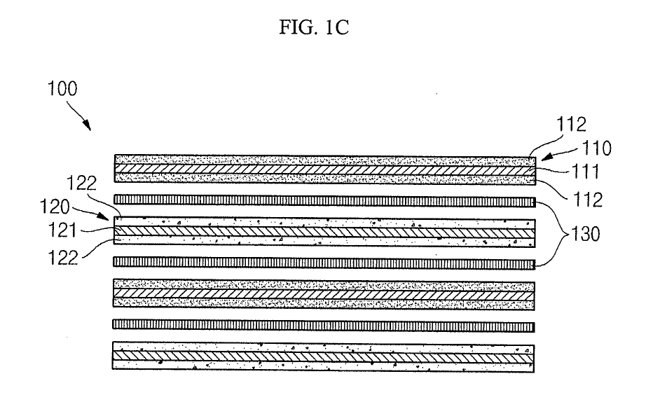

FIG. 1A is a plan view of an electrode assembly according to an embodiment of the present invention, FIG. 1B is an exploded perspective view of FIG. 1A, FIG. 1C is a cross-sectional view taken along the line 1c-1c of FIG. 1A.

As shown in FIGS. 1A and 1B, the electrode assembly 100 according to an embodiment of the present invention includes a positive electrode plate 110 having positive electrode tabs 113a and 113b, a negative electrode plate 120 having negative electrode tabs 123a and 123b and a separator 130 located between the positive electrode plate 110 and the negative electrode plate 120.

In more detail, the positive electrode tabs 113a and 113b may be attached to opposite regions of the positive electrode plate 110 facing each other, and the negative electrode tabs 123a and 123b may be attached to opposite regions of the negative electrode plate 120 facing each other.

Therefore, in the electrode assembly 100 according to an embodiment of the present invention, current input/output paths through the positive electrode tabs 113a and 113b and the negative electrode tabs 123a and 123b are formed at opposite sides, thereby suppressing cell deterioration while preventing concentrated local heat generation.

In one embodiment, the positive electrode plate 110 includes a first side 111a and a second side 111b spaced from and parallel to each other. In addition, the negative electrode plate 120 also includes a first side 121a and a second side 121b spaced from and parallel to each other. The first side 111a of the positive electrode plate 110 and the first side 121a of the negative electrode plate 120 are positioned to substantially overlap each other, and the second side 111b of the positive electrode plate 110 and the second side 121b of the negative electrode plate 120 are positioned to substantially overlap each other. Further, the positive electrode plate 110 and the negative electrode plate 120 are positioned at different layers.

In one embodiment, the positive electrode tabs include a first positive electrode tab 113a and a second positive electrode tab 113b. In more detail, the positive electrode tabs include a first positive electrode tab 113a extending a fixed length to the outside through the first side 111a of the positive electrode plate 110 and a second positive electrode tab 113b extending a fixed length to the outside through the second side 111b of the positive electrode plate 110. In addition, the negative electrode tabs include a first negative electrode tab 123a and a second negative electrode tab 123b. In more detail, the negative electrode tabs include a first negative electrode tab 123a extending a fixed length to the outside through the first side 121a of the negative electrode plate 120 and a second negative electrode tab 123b extending a fixed length to the outside through the second side 121b of the negative electrode plate 120.

Therefore, in the electrode assembly 100 according to the present invention, the first positive electrode tab 113a of the positive electrode tabs extends in a first direction, and the second positive electrode tab 113b extends in a second direction generally opposite to the first direction. In addition, the first negative electrode tab 123a of the negative electrode tabs extends in a first direction, and the second negative electrode tab 123b extends in a second direction generally opposite to the first direction. Accordingly, current input/output paths are not concentrated on any local region but rather are dispersed in the first direction and the second direction opposite to the first direction.

In addition, an imaginary first line 1 may be drawn between the first positive electrode tab 113a and the second positive electrode tab 113b, and an imaginary second line 2 may be drawn between the first negative electrode tab 123a and the second negative electrode tab 123b. Here, it is assumed that the imaginary first line 1 and the imaginary second line 2 are both straight lines. Then, as shown in FIG. 1A, the imaginary first line 1 and the imaginary second line 2 are spaced from and parallel to each other. In other words, the first positive electrode tab 113a and the second positive electrode tab 113b extend a fixed length in opposite directions along the imaginary first line 1, and the first negative electrode tab 123a and the second negative electrode tab 123b also extend a fixed length in opposite directions along the imaginary second line 2. In addition, the first positive electrode tab 113a and the first negative electrode tab 123a are formed outwardly from the first sides 111 and 121 to be parallel with each other, and the second positive electrode tab 113b and the second negative electrode tab 123b are formed outwardly from the second sides 112 and 122 to be parallel with each other.

In the electrode assembly 100 according to an embodiment of the present invention, a positive current path is formed through a first direction and a second direction opposite to the first direction, and a negative current path is formed through a first direction and a second direction opposite to the first direction. Therefore, current paths can be dispersed, thereby suppressing a cell from deteriorating while preventing concentrated local heat generation of the cell.

In one embodiment, the positive electrode plate 110, the separator 130 and the negative electrode plate 120 may have a stacked structure. The present invention does not limit the number of members stacked to that illustrated herein. In addition, in the stacked structure, the positive electrode tabs 113a and 113b and the negative electrode tabs 123a and 123b are stacked.

As described above, the electrode assembly 100 according to the present invention is suitable for a large-area, large-capacity cell, rather than a small-area, small-capacity cell. In particular, in a case of a large-area cell, a variety of current input/output paths exist, thereby efficiently suppressing concentrated local heat generation and efficiently preventing cell deterioration accordingly.

In addition, the positive electrode plate 110, the separator 130 and the negative electrode plate 120 may take any one of quadrilateral, square and rectangular shapes, but aspects of the present invention are not limited thereto. Thus, the electrode assembly 100 according to the present invention may have a wound structure as well as the aforementioned stacked structure. The wound structure of the electrode assembly 100 will be described below.

As shown in FIG. 1C, the positive electrode plate 110 includes a positive electrode collector plate 111 and a positive electrode active material 112 coated on the positive electrode collector plate 111. In addition, the negative electrode plate 120 includes a negative electrode collector plate 121 and a negative electrode active material 122 coated on the negative electrode collector plate 121. In addition, the separator 130 is located between the positive electrode plate 110 and the negative electrode plate 120.

The positive electrode collector plate 111 is shaped as a substantially planar plate, and may be formed of one selected from an aluminum foil, an aluminum mesh and equivalents thereof, but aspects of the present invention are not limited thereto. The positive electrode active material 112 is coated on a region of the positive electrode collector plate 111, excluding the positive electrode tabs 113a and 113b. The positive electrode active material 112 may be formed of one selected from lithium-based oxides such as LiCoO₂, LiNiO₂ or LiMn₂O₄ and equivalents thereof, but aspects of the present invention are not limited thereto.

The negative electrode collector plate 121 is shaped as a substantially planar plate, and may be formed of one selected from a copper foil, a copper mesh and equivalents thereof, but aspects of the present invention are not limited thereto. The negative electrode active material 122 is coated on a region of the negative electrode collector plate 121, excluding the negative electrode tabs 123a and 123b. The negative electrode active material 122 may be formed of one selected from graphite and equivalents thereof, but aspects of the present invention are not limited thereto.

The separator 130 is located between the positive electrode plate 110 and the negative electrode plate 120. The separator 130 may be formed of one material having multiple pores, selected from polyethylene (PE), polypropylene (PP), a ceramic (e.g. SiO₂, TiO₂) film and equivalents thereof, but aspects of the present invention are not limited thereto.

Meanwhile, although not shown in FIG. 1C, since the positive electrode tabs 113a and 113b are electrically connected to the positive electrode collector plate 111, they may be formed of materials which are the same as or similar to those of the positive electrode collector plate 111. In an exemplary embodiment, the positive electrode tabs 113a and 113b may be formed of an aluminum foil. In addition, since the negative electrode tabs 123a and 123b are also electrically connected to the negative electrode collector plate 121, they may be formed of materials which are the same as or similar to those of the negative electrode collector plate 121. In an exemplary embodiment, the negative electrode tabs 123a and 123b may be formed of a copper foil or a nickel foil.

In practice, the first side 111a of the positive electrode plate 110 may be a first side of the positive electrode collector plate 111, and the second side 111b of the positive electrode plate 110 may be a second side of the positive electrode collector plate 111. In addition, the first side 121a of the negative electrode plate 120 may be a first side of the negative electrode collector plate 121, and the second side 121b of the negative electrode plate 120 may be a second side of the negative electrode collector plate 121.

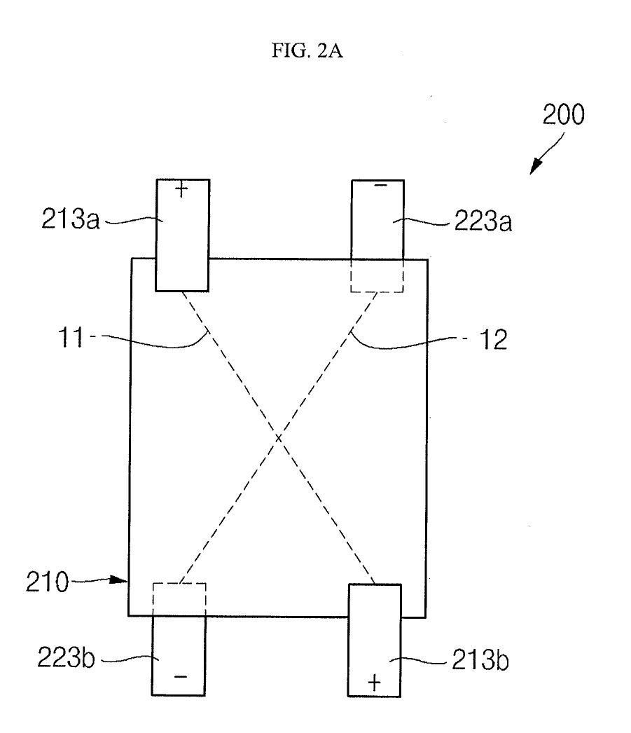

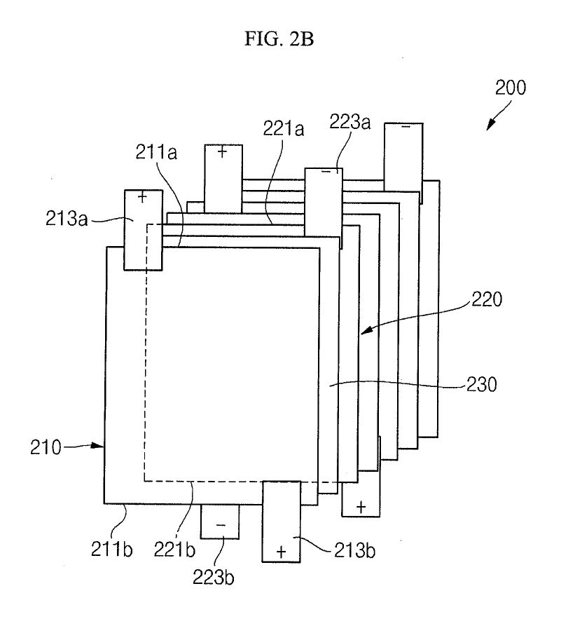

FIG. 2A is a plan view of an electrode assembly according to another embodiment of the present invention, and FIG. 2B is an exploded perspective view of FIG. 2A.

As shown in FIGS. 2A and 2B, the electrode assembly 200 according to another embodiment of the present invention has substantially the same structure as that of the electrode assembly 100, and the following description will focus on differences between the electrode assembly 100 and the electrode assembly 200.

A positive electrode plate 210 includes a first side 211a and a second side 211b spaced from and parallel with each other. In addition, a negative electrode plate 220 also includes a first side 221a and a second side 221b spaced from and parallel with each other. In addition, positive electrode tabs include a first positive electrode tab 213a extending a fixed length to the outside through the first side 211a of the positive electrode plate 210 and a second positive electrode tab 213b extending a fixed length to the outside through the second side 211b of the positive electrode plate 210. The negative electrode tabs also include a first negative electrode tab 223a extending a fixed length to the outside through the first side 221a of the negative electrode plate 220 and a second negative electrode tab 223b extending a fixed length to the outside through the second side 221b of the negative electrode plate 220.

Here, an imaginary first line 11 connecting the first positive electrode tab 213a and the second positive electrode tab 213b and an imaginary second line 12 connecting the first negative electrode tab 223a and the second negative electrode tab 223b intersect with each other. In other words, the second negative electrode tab 223b is formed in a lengthwise direction of the first positive electrode tab 213a and the second positive electrode tab 213b is formed in a lengthwise direction of the first negative electrode tab 223a. As such, the first positive electrode tab 213a and the second positive electrode tab 213b are formed at imaginary diagonally opposite ends of the positive electrode plate 210, and the first negative electrode tab 223a and the second negative electrode tab 223b are formed at imaginary diagonally opposite ends of the negative electrode plate 220.

As described above, the electrode assembly 200 according to the present invention has current input/output paths formed in directions substantially crossing each other. Therefore, concentration of local heat generation due to current input/output can be more efficiently suppressed while more efficiently preventing cell deterioration.

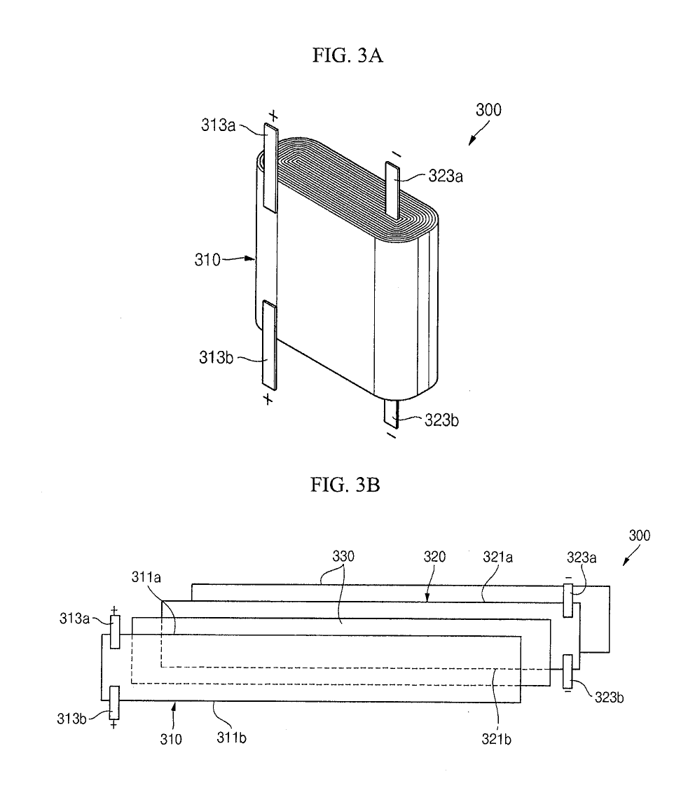

FIG. 3A is a perspective view of an electrode assembly according to another embodiment of the present invention, and FIG. 3B is an exploded perspective view illustrating a state in which the electrode assembly shown in FIG. 3A is yet to be wound.

As shown in FIGS. 3A and 3B, the electrode assembly 300 according to the present invention may have a wound structure as well as the aforementioned stacked structure. The same electrode tabs as those of the stacked electrode assembly 100 can also be applied to the wound structure, which will be described below in more detail.

A positive electrode plate 310 includes a first side 311a and a second side 311b spaced from and parallel with each other. In addition, a negative electrode plate 320 also includes a first side 321a and a second side 321b spaced from and parallel with each other.

In addition, a first positive electrode tab 313a extends outwardly through the first side 311a of the positive electrode plate 310, and a second positive electrode tab 313b extends outwardly through the second side 311b of the positive electrode plate 310. In addition, a first negative electrode tab 323a extends outwardly through the first side 321a of the negative electrode plate 320, and a second negative electrode tab 323b extends outwardly through the second side 321b of the negative electrode plate 320.

Here, an imaginary first line connecting the first positive electrode tab 313a and the second positive electrode tab 313b and an imaginary second line connecting the first negative electrode tab 323a and the second negative electrode tab 323b are spaced from and parallel with each other. Since the illustrated electrode assembly 300 is a wound type, it is necessary to design the electrode assembly 300 such that the first and second positive electrode tabs are spaced from the first and second negative electrode tabs in consideration of the number of turns.

In addition, the electrode assembly 300 is configured such that the positive electrode plate 310, the negative electrode plate 320 and the separator 330 are elongated in rectangular shapes. Therefore, the electrode assembly 300 may be wound in a substantially hexahedral shape. It is generally known that the wound electrode assembly 300 can be more easily fabricated than the stacked electrode assembly 300.

As described above, in the wound electrode assembly 300 according to the present invention, since the positive electrode tabs 313a and 313b and the negative electrode tabs 323a and 323b are formed in opposite directions, current paths can be dispersed, thereby suppressing a cell from deteriorating while preventing concentrated local heat generation of the cell.

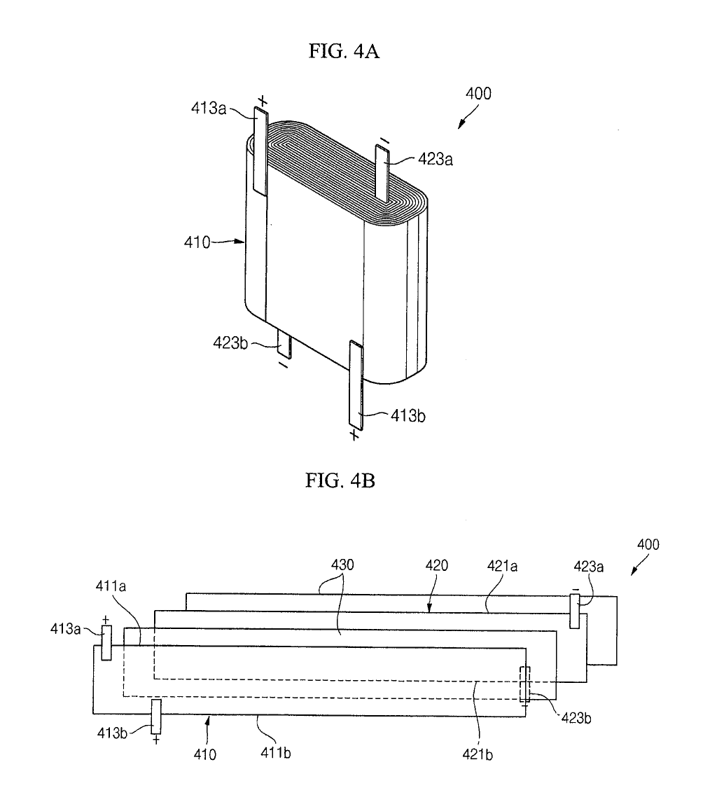

FIG. 4A is a perspective view of an electrode assembly according to another embodiment of the present invention, and FIG. 4B is an exploded perspective view illustrating a state in which the electrode assembly shown in FIG. 4A is yet to be wound.

As shown in FIGS. 4A and 4B, the electrode assembly 400 according to another embodiment of the present invention has substantially the same structure as that of the electrode assembly 300, and the following description will focus on differences between the electrode assembly 300 and the electrode assembly 400.

A positive electrode plate 410 includes a first side 411a and a second side 411b spaced from and parallel with each other. In addition, a negative electrode plate 420 also includes a first side 421a and a second side 421b spaced from and parallel with each other. In addition, positive electrode tabs include a first positive electrode tab 413a extending a fixed length to the outside through the first side 411a of the positive electrode plate 410 and a second positive electrode tab 413b extending a fixed length to the outside through the second side 411b of the positive electrode plate 410. The negative electrode tabs also include a first negative electrode tab 423a extending a fixed length to the outside through the first side 421a of the negative electrode plate 420 and a second negative electrode tab 423b extending a fixed length to the outside through the second side 421b of the negative electrode plate 420.

In one embodiment, an imaginary first line connecting the first positive electrode tab 413a and the second positive electrode tab 413b and an imaginary second line connecting the first negative electrode tab 423a and the second negative electrode tab 423b intersect with each other. In other words, the second negative electrode tab 423b is formed in a lengthwise direction of the first positive electrode tab 413a and the second positive electrode tab 413b is formed in a lengthwise direction of the first negative electrode tab 423a. As such, the first positive electrode tab 413a is formed in a lengthwise direction of the second negative electrode tab 423b and the first negative electrode tab 423a is formed in a lengthwise direction of the second positive electrode tab 413b.

As described above, the electrode assembly 400 according to the present invention has current input/output paths formed in directions substantially crossing each other. Therefore, concentration of local heat generation due to current input/output can be more efficiently suppressed while more efficiently preventing cell deterioration.

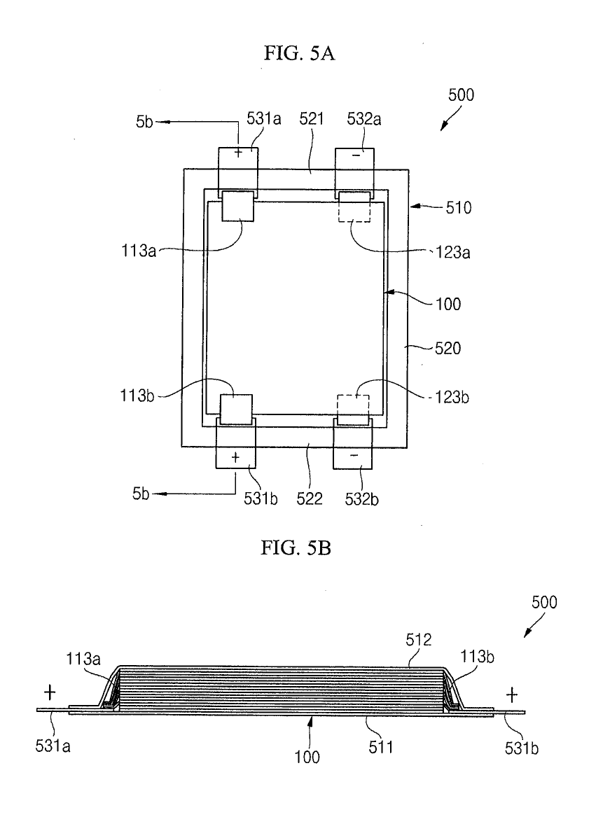

FIG. 5A illustrates a secondary battery according to another embodiment of the present invention, and FIG. 5B is a cross-sectional view taken along the line 5a-5a of FIG. 5A.

In FIGS. 5A and 5B, an electrode assembly 100 is substantially the same as that shown in FIGS. 1A to 1C, and thus a repeated description of the electrode assembly 100 will be omitted.

As shown in FIGS. 5A and 5B, the electrode assembly 100 is completely surrounded by a sheath member 510. The sheath member 510 includes a first sheath member 511 and a second sheath member 512. The first sheath member 511 closely contacts one side (e.g., a bottom surface) of the electrode assembly 100, and the second sheath member 512 closely contacts other sides (e.g., a top surface and four side surfaces) of the electrode assembly 100. In addition, the sheath member 510 has an adhesion part 520 formed at a region corresponding to the outer side of the electrode assembly 100, the adhesion part 520 adhering the first sheath member 511 and the second sheath member 512 to each other.

Here, the sheath member 510 may be configured such that an insulating layer is coated on both surfaces of, for example, a metal foil. In addition, the adhesion part 520 is formed of an adhesive agent. Alternatively, the adhesion part 520 may be a part welded when the first and second sheath members 511 and 512 are welded to each other.

Meanwhile, the adhesion part 520 may be defined by a first region 521 and a second region 522 spaced from and parallel with each other. Here, a first positive electrode member 531a and a first negative electrode member 532a may extend from the inside to the outside of the sheath member 510 through the first region 521. In addition, a second positive electrode member 531b and a second negative electrode member 532b may extend from the inside to the outside of the sheath member 510 through the second region 522.

In addition, within the sheath member 510, the first positive electrode tab 113a of the electrode assembly 100 is connected to the first positive electrode member 531a and the first negative electrode tab 123a is connected to the first negative electrode member 532a. In addition, within the sheath member 510, the second positive electrode tab 113b of the electrode assembly 100 is connected to the second positive electrode member 531b and the second negative electrode tab 123b is connected to the second negative electrode member 532b.

Likewise, assuming that an imaginary first line is drawn between a first positive electrode member 531a and a second positive electrode member 531b, and an imaginary second line is drawn between a first negative electrode member 532a and a second negative electrode member 532b, the secondary battery 500 according to the present invention is configured such that the imaginary first line and the imaginary second line are spaced from and parallel to each other.

Therefore, in the electrode assembly 500 according to the present invention, current input/output paths are formed at opposite sides, thereby suppressing cell deterioration while preventing concentrated local heat generation.

In addition, although not shown, one selected from a liquid electrolyte, a polymer electrolyte and equivalents thereof is accommodated in the sheath member 510.

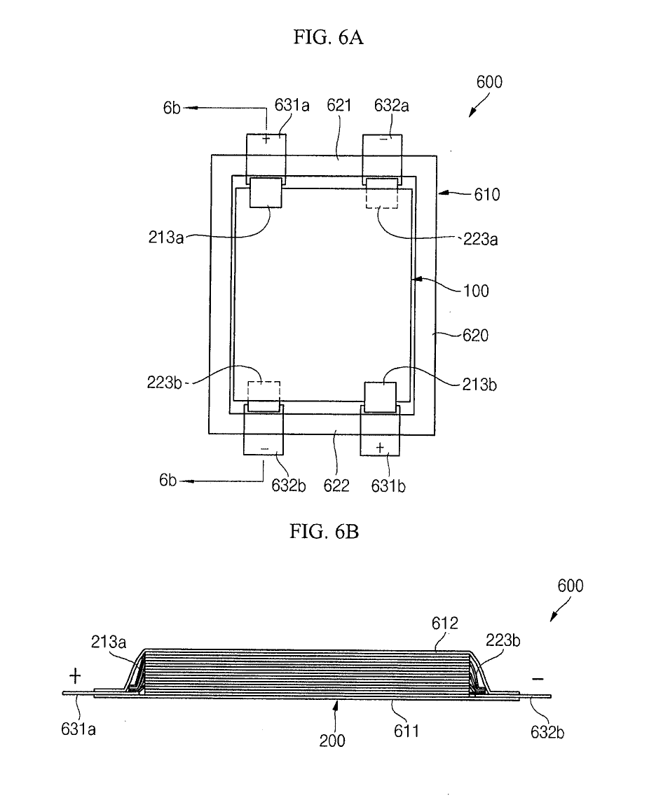

FIG. 6A illustrates a secondary battery according to another embodiment of the present invention, and FIG. 6B is a cross-sectional view taken along the line 6a-6a of FIG. 6A.

In FIGS. 6A and 6B, an electrode assembly 200 is substantially the same as that shown in FIGS. 2A and 2B, and thus a repeated description of the electrode assembly 200 will be omitted. In addition, since a sheath member 610 is also substantially the same as the sheath member 510, a description of the sheath member 610 will also be omitted.

As shown in FIGS. 6A and 6B, assuming that an imaginary first line is drawn between a first positive electrode member 631a and a second positive electrode member 631b, and an imaginary second line is drawn between a first negative electrode member 632a and a second negative electrode member 632b, the secondary battery 600 according to the present invention is configured such that the imaginary first line and the imaginary second line cross each other.

Here, a first positive electrode tab 213a of the electrode assembly 200 is connected to the first positive electrode member 631a and a second positive electrode tab 213b of the electrode assembly 200 is connected to the second positive electrode member 631b. In addition, a first negative electrode tab 223a of the electrode assembly 200 is connected to the first negative electrode member 632a and a second positive electrode tab 223b of the electrode assembly 200 is connected to the second negative electrode member 632b.

As described above, the electrode assembly 500 according to the present invention has current input/output paths formed in directions substantially crossing each other. Therefore, concentration of local heat generation due to current input/output can be more efficiently suppressed while more efficiently preventing cell deterioration.

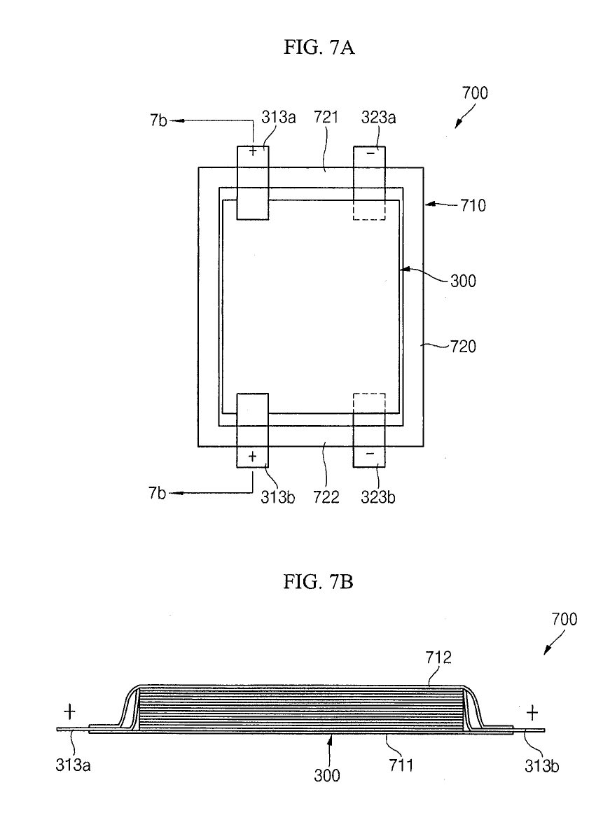

FIG. 7A illustrates a secondary battery according to another embodiment of the present invention, and FIG. 7B is a cross-sectional view taken along the line 7a-7a of FIG. 7A.

In FIGS. 7A and 7B, an electrode assembly 300 is substantially the same as that shown in FIGS. 3A and 3B, and thus a description of the electrode assembly 300 will be omitted. In addition, since a sheath member 710 is also substantially the same as the sheath member 710, a description of the sheath member 710 will also be omitted.

As shown in FIGS. 7A and 7B, a first positive electrode tab 313a and a second positive electrode tab 313b may directly extend outwardly through a first adhesion part 721 and a second adhesion part 722 of a sheath member 710. In addition, a first negative electrode tab 323a and a second negative electrode tab 323b may also directly extend outwardly through the first adhesion part 721 and the second adhesion part 722 of the sheath member 710.

In addition, assuming that an imaginary first line is drawn between a first positive electrode tab 313a and a second positive electrode tab 313b, and an imaginary second line is drawn between a first negative electrode tab 323a and a second negative electrode tab 323b, the secondary battery 700 according to the present invention is configured such that the imaginary first line and the imaginary second line are spaced from and parallel to each other.

Therefore, in the electrode assembly 700 according to the present invention, current input/output paths are formed at opposite sides, thereby suppressing cell deterioration while preventing concentrated local heat generation.

In addition, unlike in the secondary battery 600, in the secondary battery 700 according to the present invention, a process of connecting a plurality of positive electrode tabs to a positive electrode member and a process of connecting a plurality of negative electrode tabs to a negative electrode member may be omitted. Therefore, the secondary battery 700 employing the wound electrode assembly 300 can be fabricated in a simpler manner than the secondary battery 500 or 600 employing the stacked electrode assembly.

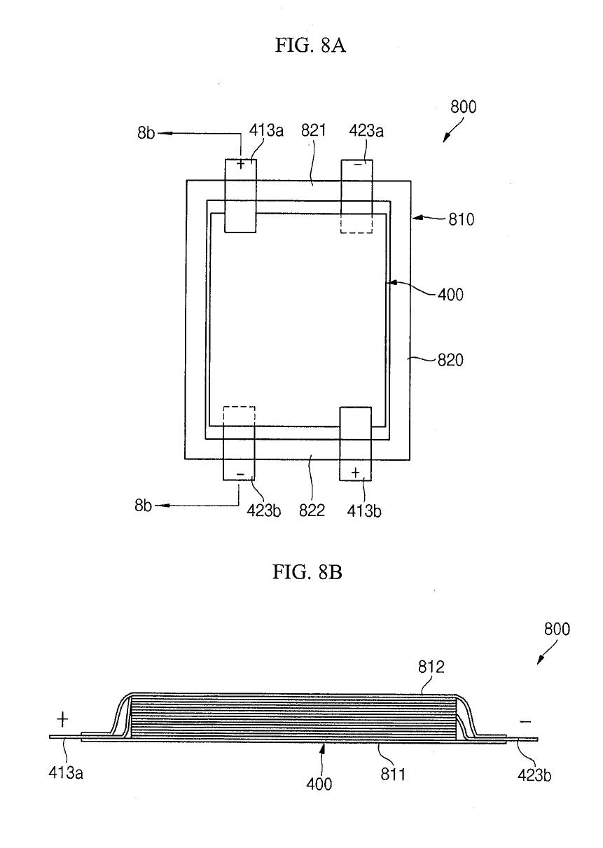

FIG. 8A illustrates a secondary battery according to another embodiment of the present invention, and FIG. 8B is a cross-sectional view taken along the line 8a-8a of FIG. 8A.

In FIGS. 8A and 8B, an electrode assembly 400 is substantially the same as that shown in FIGS. 4A and 4B, and thus a description of the electrode assembly 400 will be omitted. In addition, since a sheath member 810 is also substantially the same as the aforementioned sheath member, a description of the sheath member 810 will also be omitted.

Assuming that an imaginary first line is drawn between a first positive electrode tab 413a and a second positive electrode tab 413b, and an imaginary second line is drawn between a first negative electrode tab 423a and a second negative electrode tab 423b, the secondary battery 800 according to the present invention is configured such that the imaginary first line and the imaginary second line cross each other. In other words, the second negative electrode tab 423b is formed in a lengthwise direction of the first positive electrode tab 413a and the second positive electrode tab 413b is formed in a lengthwise direction of the first negative electrode tab 423a.

Therefore, in the secondary battery 800 according to the present invention, since current input/output paths are formed in directions substantially crossing each other, concentration of local heat generation due to current input/output can be more efficiently suppressed while more efficiently preventing cell deterioration.

The electrode assembly and the secondary battery having the same according to exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electrode assembly comprising:
a first electrode plate having a plurality of first electrode tabs, wherein each one of the first electrode tabs is attached to a region generally opposite to and facing each another of the first electrode tabs;
a second electrode plate having a plurality of second electrode tabs, wherein each one of the second electrode tabs is attached to a region generally opposite to and facing each another of the second electrode tabs; and
a separator located between the first electrode plate and the second electrode plate.

2. The electrode assembly of claim 1, wherein the first electrode plate and the second electrode plate each include a first side and a second side substantially parallel with each other; the first electrode tabs include a first positive electrode tab protruding from the first side of the first electrode plate and a second positive electrode tab protruding from the second side of the first electrode plate; and the second electrode tabs include a first negative electrode tab protruding from the first side of the second electrode plate and a second negative electrode tab protruding from the second side of the second electrode plate.

3. The electrode assembly of claim 2, wherein the first positive electrode tab and the second positive electrode tab are aligned with the first negative electrode tab and the second negative electrode tab such that an imaginary first line connecting the first positive electrode tab and the second positive electrode tab and an imaginary second line connecting the first negative electrode tab and the second negative electrode tab are substantially parallel with each other.

4. The electrode assembly of claim 2, wherein the first positive electrode tab and the second positive electrode tab are oriented with the first negative electrode tab and the second negative electrode tab such that an imaginary first line connecting the first positive electrode tab and the second positive electrode tab and an imaginary second line connecting the first negative electrode tab and the second negative electrode tab intersect with each other.

5. The electrode assembly of claim 1, wherein the first electrode plate, the separator and the second electrode plate are stacked together.

6. The electrode assembly of claim 1, wherein the first electrode tabs and the second electrode tabs, respectively, are stacked together.

7. The electrode assembly of claim 1, wherein the first electrode plate, the separator and the second electrode plate are wound together.

8. The electrode assembly of claim 1, wherein the first electrode plate, the separator and the second electrode plate are square or rectangular.

9. An electrode assembly comprising:
a first electrode plate including a positive electrode collector plate, a positive electrode active material coated on the positive electrode collector plate and a plurality of first electrode tabs, wherein each one of the first electrode tabs is attached to a region generally opposite to and facing each another of the first electrode tabs;
a second electrode plate including a negative electrode collector plate, a negative electrode active material coated on the negative electrode collector plate and a plurality of second electrode tabs, wherein each one of the first electrode tabs is attached to a region generally opposite to and facing each another of the second electrode tabs; and
a separator located between the first electrode plate and the second electrode plate.

10. The electrode assembly of claim 9, wherein the positive electrode collector plate and the negative collector plate each include a first side and a second side parallel with each other; wherein the first electrode tabs include a first positive electrode tab protruding from the first side of the first electrode plate and a second positive electrode tab protruding from the second side of the first electrode plate; and wherein the second electrode tabs include a first negative electrode tab protruding from the first side of the first electrode plate and a second negative electrode tab protruding from the second side of the first electrode plate.

11. A secondary battery comprising:
an electrode assembly comprising:
a first electrode plate having a plurality of first electrode tabs, wherein each one of the first electrode tabs is attached to a region generally opposite to and facing each another of the first electrode tabs;
a second electrode plate having a plurality of second electrode tabs, wherein each one of the second electrode tabs is attached to a region generally opposite to and facing each another of the second electrode tabs; and
a separator located between the first electrode plate and the second electrode plate.

12. The secondary battery of claim 11, further comprising a sheath member surrounding the electrode assembly, wherein the sheath member includes a first sheath member contacting one side of the electrode assembly, and a second sheath member contacting another side of the electrode assembly.

13. The secondary battery of claim 12, wherein the sheath member has an adhesion part that adheres the first sheath member and the second sheath member to a region outside of the electrode assembly.

14. The secondary battery of claim 13, wherein the first electrode tabs and the second electrode tabs protrude from the sheath member through the adhesion part.

15. The secondary battery of claim 13, wherein the positive electrode member and the negative electrode member protrude from the sheath member through the adhesion part, the first electrode tabs and the second electrode tabs being coupled to the positive electrode member and the negative electrode member, respectively, from inside of the sheath member.
